(19) United States
(12) Patent Application Publication
(10) Pub. No.: US 2014/0325975 A1
(43) Pub. Date: Nov. 6, 2014

(54) SWING RELIEF ENERGY REGENERATION APPARATUS OF AN EXCAVATOR

(71) Applicants: Sung-Gon Kim, Changwon-si (KR); Jae-Hong Kim, Gimhae-si (KR)

(72) Inventors: Sung-Gon Kim, Changwon-si (KR); Jae-Hong Kim, Gimhae-si (KR)

(73) Assignee: VOLVO CONSTRUCTION EQUIPMENT AB, Eskilstuna (SE)

(21) Appl. No.: 14/361,622

(22) PCT Filed: Dec. 2, 2011
(86) PCT No.: PCT/KR2011/009296

§ 371 Date: May 29, 2014

(51) Int. Cl. E02F 9/22; F15B 11/024; F15B 21/14

(52) U.S. Cl. CPC E02F 9/2217; F15B 21/14; F15B 11/024; F15B 2011/0243
USPC 60/414; 60/420

(57) ABSTRACT

Disclosed is a swing relief energy regeneration apparatus in which working oil relieved into a hydraulic tank is stored in a pressure accumulator during swing and deceleration to recycle the stored pressure. The swing relief energy regeneration apparatus includes: a hydraulic pump and hydraulic motor; a swing motor connected to the hydraulic pump through first and second paths; a flow rate control valve controlling the working oil supplied from the hydraulic pump into the swing motor; a first passage having both ends branched and connected to the first and second paths to allow the working oil to move in one direction toward the first or second path from the hydraulic tank; a second passage defined parallel to the first passage and having both ends branched and connected to the upstream sides of the first and second paths to allow the working oil to move in one direction toward the hydraulic tank from the first or second path; a pressure accumulator disposed in a recycling path having one end connected to the second passage and the other end connected to the hydraulic motor to store the working oil relieved into the hydraulic tank; and a sluice valve opened to supply the working oil into the hydraulic motor from the pressure accumulator when the manipulation amount of a manipulation lever for controlling the operation of the excavator exceeds a set value.

### FIELD OF THE INVENTION

The present invention relates to an apparatus for recovering swing relief energy for an excavator. More particularly, the present invention relates to a an apparatus for recovering swing relief energy for an excavator, in which a hydraulic fluid relieved to a hydraulic tank from a swing motor is stored in an accumulator during the swing acceleration and deceleration of the excavator so that the amount of fuel consumed of an engine can be reduced by recycling the stored hydraulic fluid.

### BACKGROUND OF THE INVENTION

A swing apparatus for an excavator shown in FIG. 1 in accordance with the prior art includes:

a variable displacement hydraulic pump (hereinafter, referred to as “hydraulic pump”) 1 that is connected to an engine) (not shown);

a swing motor 4 (having a function of a hydraulic motor and a hydraulic pump) that is connected to the hydraulic pump 1 through first and second path 2 and 3 and is driven in a forward or reverse direction to swing an upper swing structure 15;

a flow rate control valve 5 that is installed in the first and second paths 2 and 3 between the hydraulic pump 1 and the swing motor 4 and is shifted to control a start, a stop, and a direction change of the swing motor 4 in response to a control signal from the outside;

a first flow path 7 that is branch-connected at one end thereof to the first path 2 and includes a first check valve 6 installed thereon;

a second flow path 10 that is branch-connected at one end thereof to the first path 2 and fluidically communicates with the other end of a path 8 fluidically communicating with at one end thereof to the other end of the first flow path 7, the second flow path 10 including a first port relief valve 9 installed thereon to relieve some of a hydraulic fluid to a hydraulic tank T2 when an overload occurs in the first path 2;

a third flow path 12 that is branch-connected at one end thereof to the second path 3 and fluidically communicates with the other end of the first flow path 7 and an intersection part of the path 8, the third flow path including a second check valve installed thereon; and

a fourth flow path 14 that is branch-connected at one end thereof to the second path 3 and fluidically communicates with the other end of the second flow path 10 and the intersection part of the path 8, the fourth flow path including a second check valve installed thereon to relieve some of a hydraulic fluid to the hydraulic tank T2 when an overload occurs in the second path 3.

In this case, the second and fourth flow paths 10 and 14 are provided in parallel with the first and third flow paths 7 and 12 branch-connected to the first and second paths 2 and 3 such that they are branch-connected to the first and second paths 2 and 3.

A non-explained reference numeral 15 denotes an upper swing structure that swivels an upper frame in a forward or reverse direction with respect to a lower traveling structure of the excavator according to the drive of the swing motor 4.

A) A case will be described hereinafter in which the swing motor is rotated in a forward direction (e.g., a case in which a hydraulic fluid flows into a port “A” of the swing motor 4 and is discharged from a port “B” of the swing motor 4.).

When a spool of the flow rate control valve 5 is shifted to the left on the drawing sheet in response to a control signal applied from the outside, the hydraulic pump 1 is connected to the port “A” of the swing motor 4 through the first path 2, and the port “B” of the swing motor 4 is connected to the hydraulic tank T2 through the second path 3.

Thus, a hydraulic fluid discharged from the hydraulic pump 1 is supplied to the port “A” of the swing motor 4 along the first path 2 via the flow rate control valve 5 to cause the swing motor 4 to be rotated in a forward direction. At this time, a hydraulic fluid discharged from the port “B” of the swing motor 4 is fed back to the hydraulic tank T1 via the second path 3 and the flow rate control valve 5.

B) A case will be described hereinafter in which the swing motor is rotated in a reverse direction (e.g., a case in which a hydraulic fluid flows into the port “B” of the swing motor 4 and is discharged from a port “A” of the swing motor 4.).

When the spool of the flow rate control valve 5 is shifted to the right on the drawing sheet in response to a control signal applied from the outside, the hydraulic pump 1 is connected to the port “B” of the swing motor 4 through the second path 3, and the port “A” of the swing motor 4 is connected to the hydraulic tank T2 through the first path 2.

Thus, the hydraulic fluid discharged from the hydraulic pump 1 is supplied to the port “B” of the swing motor 4 along the second path 3 via the flow rate control valve 5 to cause the swing motor 4 to be rotated in a reverse direction. At this time, a hydraulic fluid discharged from the port “A” of the swing motor 4 is fed back to the hydraulic tank T1 via the first path 2 and the flow rate control valve 5.

FIG. 2 is a graph showing the pressure of the ports “A” and “B” of a swing motor during a loading work in an excavator in accordance with the prior art.

In FIG. 2, a graph curve (a) means the drive of the swing motor to the left direction (LH), and a graph curve (b) means the drive of the swing motor to the right direction (RH).

A section 1 and a section 2 indicate that an operator decelerates the upper swing structure 15 after the swing acceleration thereof to swivel the upper swing structure 15 to a desired swing position.

In a section 1, when the spool of the flow rate control valve 5 is shifted to the left on the drawing sheet in response to a control signal applied from the outside, the hydraulic fluid discharged from the hydraulic pump 1 is supplied to the port “A” of the swing motor 4 along the first path 2 via the flow rate control valve 5. On the other hand, a hydraulic fluid discharged from the port “B” of the swing motor 4 is fed back to the hydraulic tank T1. Like this, the upper swing structure 15 can be swiveled by the drive of the swing motor 4.

In a section 2, the spool of the flow rate control valve 5 is shifted to a neutral position so that the upper swing structure 15 being swiveled can be abruptly decelerated. As a result, the first path 3 along which the hydraulic fluid from the hydraulic pump 1 is supplied to the swing motor 4 and the second path along which the hydraulic fluid from the swing motor 4 is fed back to the hydraulic tank T1 are blocked, respectively. In this case, since the swiveling of the upper swing structure 15 is not stopped immediately due to a heavy weight and a moment of inertia of the upper swing structure 15, a predetermined time is needed to stop the swiveling of the upper swing structure 15. That is, since the spool of the flow rate control valve 5 is shifted to the neutral position and then the swing motor 4 continues to be rotated, an overload occurs in the second path 3.

At this time, a hydraulic fluid insufficient in the port “A” due to continuous rotation of the swing motor 4 is replenished by being sucked in from the hydraulic tank T2 through the first check valve 6, and the hydraulic fluid is discharged through the port “B” of the swing motor 4.

For this reason, the pressure of a high-pressure hydraulic fluid discharged from the port “B” of the swing motor 4 is boosted up to a relief pressure, which acts as a force that stops the swiveling of the upper swing structure 15.

The sections 3 to 4 indicates that the upper swing structure 15 being swiveled is again accelerated in a reverse direction and then is decelerated to return to an initial position.

In a section 3, when the spool of the flow rate control valve 5 is shifted to the left on the drawing sheet in response to a control signal applied from the outside, the hydraulic fluid discharged from the hydraulic pump 1 is supplied to the port “B” of the swing motor 4 along the second path 3 via the flow rate control valve 5. On the other hand, a hydraulic fluid discharged from the port “B” of the swing motor 4 is fed back to the hydraulic tank T1 to cause the swing motor 4 to be driven to swivel the upper swing structure 15 in a reverse direction.

In this case, if the swing acceleration of the upper swing structure 15 held in a stopped state is increased, the hydraulic fluid whose pressure exceeds a preset pressure generated in the second path 3 is drained to the hydraulic tank T2 through the second port relief valve 13. At this time, a high pressure is formed in the port “B” of the swing motor 4, and thus the upper swing structure 15 is decelerated.

In a section 4, in the case where the upper swing structure 15 is swing-decelerated, even when the spool of the flow rate control valve 5 is shifted to the neutral position, the swing motor 4 continues to rotate due to a moment of inertia. A hydraulic fluid insufficient in the port “B” due to continuous rotation of the swing motor 4 is replenished by being sucked in from the hydraulic tank T2 through the second check valve 11.

In this case, a high-pressure hydraulic fluid generated in the port “A” of the swing motor 4 is drained to the hydraulic tank T2 through the first port relief valve 9.

The swing apparatus for an excavator in accordance with the prior art enables a large amount of hydraulic fluid to be supplied to the swing motor 4 due to a great moment of inertia of the upper swing structure 15 held in a stopped state. For this reason, some of the hydraulic fluid is drained to the hydraulic tank T2 via the first port relief valve 9 or the second port relief valve 13, thereby causing an energy loss.

In addition, the conventional swing apparatus for an excavator entails a problem in that hydraulic energy that can be regenerated is consumed through the first port relief valve 9 or the second port relief valve 13 during the swing deceleration of the upper swing structure 15.

Meanwhile, when the manipulation lever is finely manipulated to drive the swing motor 4 by an operator, the pressure needed for the swing acceleration and deceleration is low. Thus, the first port relief valve 9 or the second port relief valve 13 is not opened, and the hydraulic fluid supplied to the swing motor 4 can be controlled under the control of the spool of the flow rate control valve 5.

### DETAILED DESCRIPTION OF THE INVENTION

### Technical Problems

Accordingly, the present invention has been made to solve the aforementioned problem occurring in the prior art, and it is an object of the present invention to provide an apparatus for recovering swing relief energy for an excavator, in which a hydraulic fluid relieved to a hydraulic tank from a swing motor is stored in the accumulator during the swing acceleration and deceleration of the upper swing structure due to a great moment of inertia of the upper swing structure held in a stopped state so that when a hydraulic motor connected to an engine is driven, the amount of fuel consumed to drive the engine can be reduced.

### Technical Solution

To accomplish the above object, in accordance with an embodiment of the present invention, there is provided an apparatus for recovering swing relief energy for an excavator, the apparatus including:

a variable displacement hydraulic pump and a hydraulic motor that are connected to an engine;

a swing motor connected to the hydraulic pump 51 through a first path and a second path and configured to be driven to swing an upper swing structure;

a flow rate control valve installed in the first and second paths between the hydraulic pump and the swing motor and configured to be shifted to control a start, a stop, and a direction change of the swing motor in response to a control signal from the outside;

a first flow path branch-connected at both ends thereof to the first and second paths, the first flow path including first and second check valves installed thereon to permit movement of a hydraulic fluid in one direction from a hydraulic tank to the first path or second path side;

a second flow path provided in parallel with the first flow path and branch-connected at both ends thereof to the upstream sides of the first and second paths, the second flow path including third and fourth check valves installed thereon to permit movement of the hydraulic fluid in one direction from the first path or second path to a hydraulic tank side;

an accumulator installed in a regeneration path connected at one end thereof to the second flow path between the third and fourth check valves and connected at the other end thereof to the hydraulic motor, the accumulator being configured to store a high-pressure hydraulic fluid that is relieved from the first and second paths to the hydraulic tank during the swing of the upper swing structure; and

a control valve installed in the regeneration path between the accumulator and the hydraulic motor and configured to be shifted to open the regeneration path in response to the control signal from the outside so as to supply the hydraulic fluid from the accumulator to the hydraulic motor if a manipulation amount of an manipulation lever that controls the drive of the excavator exceeds a preset value.

In accordance with a preferred embodiment of the present invention, a solenoid value that is shifted to open or close the regeneration path in response to the input of an electric signal from the outside may be used as the control valve.

If the pressure of the accumulator exceeds a preset value, the hydraulic fluid stored in the accumulator may be supplied to the hydraulic motor that is connected to an engine cooling fan to drive the engine cooling fan.

If the number of driving revolutions of the engine does not reach a preset number of revolutions, the hydraulic fluid stored in the accumulator may be supplied to the hydraulic motor.

The apparatus for recovering swing relief energy for an excavator may further include:

a pressure sensor configured to detect the pressure of an upstream side of the regeneration path of the accumulator; and

a variable relief valve configured to set a control signal value according to a pressure value detected by the pressure sensor and variably adjust a difference in pressure between an inlet side port and an outlet side port based on the set control signal value,

wherein the pressure of the hydraulic fluid that is supplied to the swing motor 56 is maintained not to exceed the set value during the swing of the upper swing structure, and the high-pressure hydraulic fluid that is relieved from the first and second paths to the hydraulic tank is stored in the accumulator.

### Advantageous Effect

The apparatus for recovering swing relief energy for an excavator in accordance with an embodiment of the present invention as constructed above has the following advantages.

When the upper swing structure is decelerated after the swing acceleration thereof, the high-pressure hydraulic fluid relieved to the hydraulic tank from the swing motor is stored in the accumulator due to a great moment of inertia of the upper swing structure held in a stopped state so that when the hydraulic motor connected to the engine is driven, the amount of fuel consumed to drive the engine can be saved.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram showing a swing apparatus for an excavator in accordance with the prior art;

FIG. 2 is a graph showing the pressure of an inlet side of a swing motor during a loading work in an excavator in accordance with the prior art; and

FIG. 3 is a hydraulic circuit diagram showing an apparatus for recovering swing relief energy for an excavator in accordance with an embodiment of the present invention.

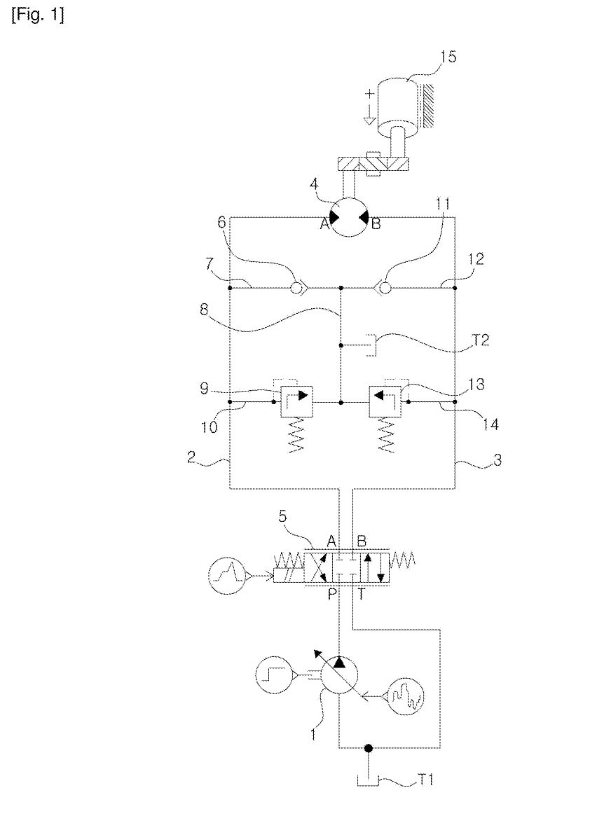

### *EXPLANATION ON REFERENCE NUMERALS OF MAIN ELEMENTS IN THE DRAWINGS*

50: engine
51: variable displacement hydraulic pump
52: hydraulic motor
53: first path
54: second path
55: upper swing structure
56: swing motor
57: flow rate control valve
58: first check valve
59: second check valve
60: first flow path
61: third check valve
62: fourth check valve
63: second flow path
64: regeneration path
65: accumulator
66: control valve
67: pressure sensor
68: variable relief valve

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

An apparatus for recovering swing relief energy for an excavator in accordance with one embodiment as shown in FIG. 3 includes:

a variable displacement hydraulic pump (hereinafter, referred to as “hydraulic pump”) 51 and a hydraulic motor 52 that are connected to an engine 50;

a swing motor 56 that is connected to the hydraulic pump 51 through a first path 53 and a second path 54 and is driven to swing an upper swing structure 55;

a flow rate control valve 57 that is installed in the first and second paths 53 and 54 between the hydraulic pump 51 and the swing motor 56 and is shifted to control a start, a stop, and a direction change of the swing motor 56 in response to a control signal from the outside;

a first flow path 60 that is branch-connected at both ends thereof to the first and second paths 53 and 54, the first flow path 60 including first and second check valves 58 and 59 installed thereon to permit movement of a hydraulic fluid in one direction from a hydraulic tank T1 to the first path 53 or second path 54 side;

a second flow path 63 that is provided in parallel with the first flow path 60 and branch-connected at both ends thereof to the upstream sides of the first and second paths 53 and 54, the second flow path 63 including third and fourth check valves 61 and 62 installed thereon to permit movement of the hydraulic fluid in one direction from the first path 53 or second path 54 to a hydraulic tank T2 side;

an accumulator 65 that is installed in a regeneration path 64 connected at one end thereof to the second flow path 63 between the third and fourth check valves 61 and 62 and connected at the other end thereof to the hydraulic motor 52, the accumulator being configured to store a high-pressure hydraulic fluid that is relieved from the first and second paths 53 and 54 to the hydraulic tank T2 during the swing of the upper swing structure 55; and

an control valve 66 that is installed in the regeneration path 64 between the accumulator 65 and the hydraulic motor 52 and configured to be shifted to open the regeneration path 64 in response to the control signal from the outside so as to supply the hydraulic fluid from the accumulator 65 to the hydraulic motor 52 if a manipulation amount of an manipulation lever that controls the drive of the excavator (e.g., a boom, an arm, or the like) exceeds a preset value.

In this case, a solenoid value that is shifted to open or close the regeneration path 64 in response to the input of an electric signal from the outside is used as the control valve 66.

Although not shown in the drawings, if the pressure of the accumulator 65 exceeds a preset value, the hydraulic fluid stored in the accumulator 65 is supplied to a hydraulic motor for a cooling fan, which is connected to a cooling fan of the engine 50 to drive the engine cooling fan.

Meanwhile, if the number of driving revolutions of the engine 50 does not reach a preset number of revolutions, the hydraulic fluid stored in the accumulator 65 is supplied to the hydraulic motor 52.

The apparatus for recovering swing relief energy for an excavator further includes a pressure sensor 67 that detects the pressure of an upstream side of the regeneration path 64 of the accumulator 65, and a variable relief valve 68 that sets a control signal value according to a pressure value detected by the pressure sensor 67 and variably adjusts a difference in pressure between an inlet side port C and an outlet side port D thereof based on the set control signal value, wherein the pressure of the hydraulic fluid that is supplied to the swing motor 56 is maintained not to exceed the set value during the swing of the upper swing structure 55, and the high-pressure hydraulic fluid that is relieved from the first and second paths 53 and 54 to the hydraulic tank T2 is stored in the accumulator 65.

Hereinafter, the operation of an apparatus for recovering swing relief energy for an excavator in accordance with an embodiment of the present invention will be described in detail with reference to the accompanying drawings.

As shown in FIG. 3, when a spool of the flow rate control valve 57 is shifted to the left on the drawing sheet in response to a control signal applied from the outside, the hydraulic pump 51 is connected to a port “A” of the swing motor 56 through the first path 53, and a port “B” of the swing motor 56 is connected to the hydraulic tank T2 through the second path 54.

For this reason, a hydraulic fluid discharged from the hydraulic pump 51 is supplied to the port “A” of the swing motor 56 along the first path 53 after passing through the flow rate control valve 57 to cause the swing motor 56 to be rotated in a forward or reverse direction. At this time, a hydraulic fluid discharged from the port “B” of the swing motor 56 is fed back to the hydraulic tank T2 via the second path 54 and the flow rate control valve 57.

On the contrary, when the spool of the flow rate control valve 57 is shifted to the right on the drawing sheet in response to the control signal applied from the outside, the hydraulic pump 51 is connected to the port “B” of the swing motor 56 through the second path 54, and the port “A” of the swing motor 56 is connected to the hydraulic tank T2 through the first path 53.

For this reason, the hydraulic fluid discharged from the hydraulic pump 51 is supplied to the port “B” of the swing motor 56 along the second path 54 after passing through the flow rate control valve 57 to cause the swing motor 56 to be rotated in a forward or reverse direction. At this time, the hydraulic fluid discharged from the port “A” of the swing motor 56 is fed back to the hydraulic tank T2 via the first path 53 and the flow rate control valve 57.

A) A case will be described hereinafter in which a high-pressure hydraulic fluid relieved to the hydraulic tank during the swing acceleration and deceleration of the upper swing structure is stored in the accumulator.

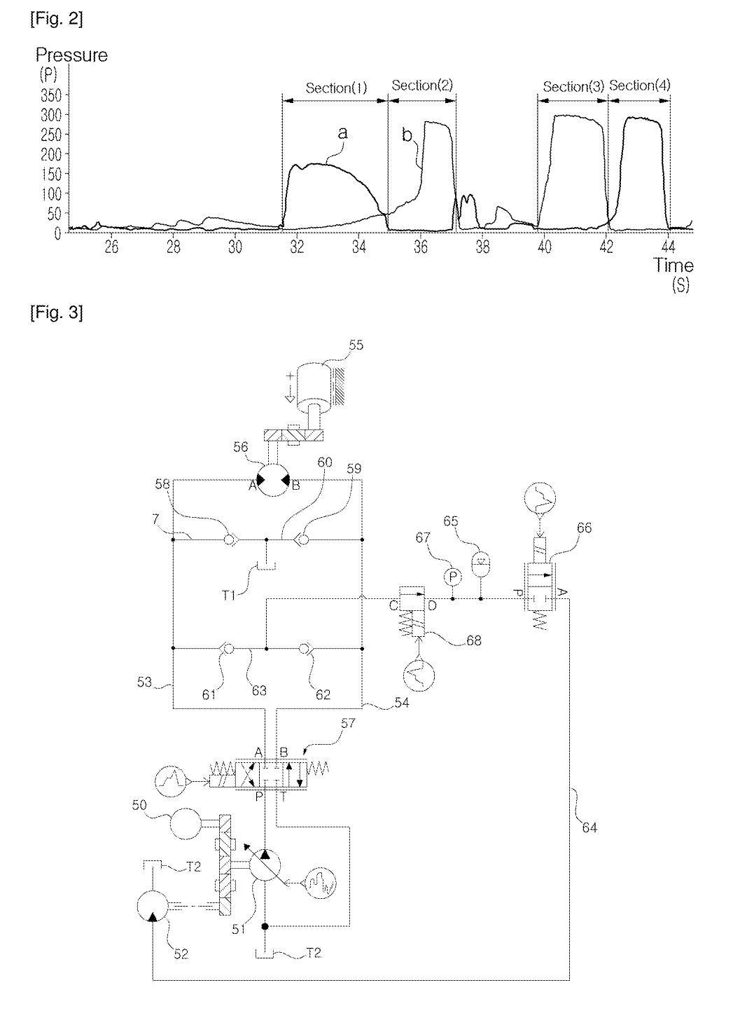

As shown in FIG. 3 and a section 1 of FIG. 2, when a spool of the flow rate control valve 57 is shifted to the left on the drawing sheet in response to a control signal applied from the outside, the hydraulic pump 51 is connected to the port “A” of the swing motor 56 through the first path 53, and the port “B” of the swing motor 56 is connected to the hydraulic tank T2 through the second path 54.

Thus, the swing motor 56 is rotated by the hydraulic fluid supplied thereto from the hydraulic pump 51 through the first path 53 to cause the upper swing structure 55 to be swiveled in a forward or reverse direction.

In this case, as shown in FIG. 3 and a section 2 of FIG. 2, when the spool of the flow rate control valve 57 is shifted to a neutral position so that the upper swing structure 55 being swiveled can be abruptly decelerated, the swiveling of the upper swing structure 55 is not stopped immediately due to a heavy weight and a moment of inertia of the upper swing structure 55. That is, since the spool of the flow rate control valve 57 is shifted to the neutral position and then the swing motor 56 continues to be rotated, an overload occurs in the second path 54. A hydraulic fluid corresponding to the overload formed in the second path 54 passes through the fourth check valve 62 installed in the second flow path 63.

Thus, the high-pressure hydraulic fluid introduced into the second flow path 63 between the third and fourth check valves 61 and 62 from the second path 54 is stored in the accumulator 65 installed in the regeneration path 64. In this case, a hydraulic fluid insufficient in the port “A” due to continuous rotation of the swing motor 56 is replenished by being sucked in from the hydraulic tank T2 through the first check valve 58 installed in the first flow path 60.

As shown in FIG. 3 and a section 3 of FIG. 2, when a spool of the flow rate control valve 57 is shifted to the right on the drawing sheet in response to the control signal applied from the outside, the hydraulic pump 51 is connected to the port “B” of the swing motor 56 through the second path 54, and the port “A” of the swing motor 56 is connected to the hydraulic tank T2 through the first path 53.

Thus, the swing motor 56 is rotated by the hydraulic fluid supplied thereto from the hydraulic pump 51 through the second path 54 to cause the upper swing structure 55 to be swiveled in a forward or reverse direction.

In this case, as shown in FIG. 3 and a section 4 of FIG. 2, when the spool of the flow rate control valve 57 is shifted to a neutral position so that the upper swing structure 55 being swiveled can be abruptly decelerated, the swiveling of the upper swing structure 55 is not stopped immediately due to a heavy weight and a moment of inertia of the upper swing structure 55. That is, since the spool of the flow rate control valve 57 is shifted to the neutral position and then the swing motor 56 continues to be rotated, an overload occurs in the first path 53. A hydraulic fluid corresponding to the overload formed in the first path 53 passes through the fourth check valve 62 installed in the second flow path 63.

Thus, the high-pressure hydraulic fluid introduced into the second flow path 63 between the third and fourth check valves 61 and 62 from the first path 53 is stored in the accumulator 65 installed in the regeneration path 64. In this case, a hydraulic fluid insufficient in the port “B” due to continuous rotation of the swing motor 56 is replenished by being sucked in from the hydraulic tank T2 through the second check valve 59 installed in the first flow path 60.

As described above, when the upper swing structure 55 is decelerated after the swing acceleration thereof, the high-pressure hydraulic fluid relieved to the hydraulic tank from the swing motor 56 is stored in the accumulator 65 via the third check valve 61 or the fourth check valve 62 installed in the second flow path 63 so that hydraulic energy can be saved.

B) A case will be described hereinafter in which the hydraulic tank stored in the accumulator during the swing acceleration of the upper swing structure is used.

As shown in FIG. 3, in the case where the hydraulic fluid from the hydraulic pump 51 is supplied to the port “A” of the swing motor 56 via the flow rate control valve 57 and the first path 53 to swing-accelerate the upper swing structure 55, an operator detects a manipulation amount of the manipulation lever (RCV) that controls the drive of the excavator (e.g., a boom, an arm, a swing motor or the like) using a detection means (not shown). If the manipulation amount of the manipulation lever (RCV) exceeds a preset value, the control valve 66 is shifted to the bottom on the drawing sheet in response to the control signal.

As a result, the high-pressure hydraulic fluid stored in the accumulator 65 is supplied to the hydraulic motor 52 along the regeneration path 64 in an opened state so that when the engine is driven by the drive of the hydraulic motor 52 connected to the engine 50, the amount of a load occurring can be reduced (i.e., a torque of the engine 50 can be reduced.)

In the meantime, a pressure value detected by the pressure sensor 67 installed on an upstream side of the regeneration path 64 is used as a control signal of the variable relief valve 68 installed in the regeneration path 64. In other words, a difference in pressure between an inlet side port C) and an outlet side port D of the variable relief valve 68 is variably adjusted by a control signal value set based on the detected pressure value of the pressure sensor 67.

For this reason, during the swing acceleration and deceleration of the upper swing structure 55, the pressure of the hydraulic fluid supplied to the swing motor 56 is maintained not to exceed a preset value (i.e., even when the pressure of the hydraulic fluid on a downstream side of the variable relief valve 68 varies, the pressure of the hydraulic fluid on an upstream side of the variable relief valve 68 is maintained as the preset value), and the high-pressure hydraulic fluid relieved to the hydraulic tank T2 from the first and second paths 53 and 54 can be stored in the accumulator 65.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, according to the present invention, when the upper swing structure is decelerated after the swing acceleration thereof, the high-pressure hydraulic fluid relieved to the hydraulic tank from the swing motor is stored in the accumulator so that when the hydraulic motor connected to the engine is driven, the amount of fuel consumed to drive the engine can be saved.

1. An apparatus for recovering swing relief energy for an excavator, the apparatus comprising:
a variable displacement hydraulic pump and a hydraulic motor that are connected to an engine;
a swing motor connected to the hydraulic pump 51 through a first path and a second path and configured to be driven to swing an upper swing structure;
a flow rate control valve installed in the first and second paths between the hydraulic pump and the swing motor and configured to be shifted to control a start, a stop, and a direction change of the swing motor in response to a control signal from the outside;
a first flow path branch-connected at both ends thereof to the first and second paths, the first flow path including first and second check valves installed thereon to permit movement of a hydraulic fluid in one direction from a hydraulic tank to the first path or second path side;
a second flow path provided in parallel with the first flow path and branch-connected at both ends thereof to the upstream sides of the first and second paths, the second flow path including third and fourth check valves installed thereon to permit movement of the hydraulic fluid in one direction from the first path or second path to a hydraulic tank side;
an accumulator installed in a regeneration path connected at one end thereof to the second flow path between the third and fourth check valves and connected at the other end thereof to the hydraulic motor, the accumulator being configured to store a high-pressure hydraulic fluid that is relieved from the first and second paths to the hydraulic tank during the swing of the upper swing structure; and
a control valve installed in the regeneration path between the accumulator and the hydraulic motor and configured to be shifted to open the regeneration path in response to the control signal from the outside so as to supply the hydraulic fluid from the accumulator to the hydraulic motor if a manipulation amount of an manipulation lever that controls the drive of the excavator exceeds a preset value.

2. The apparatus for recovering swing relief energy for an excavator according to claim 1, wherein a solenoid value that is shifted to open or close the regeneration path in response to the input of an electric signal from the outside is used as the control valve.

3. The apparatus for recovering swing relief energy for an excavator according to claim 1, wherein if the pressure of the accumulator exceeds a preset value, the hydraulic fluid stored in the accumulator is supplied to the hydraulic motor that is connected to an engine cooling fan to drive the engine cooling fan.

4. The apparatus for recovering swing relief energy for an excavator according to claim 1, wherein if the number of driving revolutions of the engine does not reach a preset number of revolutions, the hydraulic fluid stored in the accumulator is supplied to the hydraulic motor.

5. The apparatus for recovering swing relief energy for an excavator according to claim 1, further comprising:
a pressure sensor configured to detect the pressure of an upstream side of the regeneration path of the accumulator; and
a variable relief valve configured to set a control signal value according to a pressure value detected by the pressure sensor and variably adjust a difference in pressure between an inlet side port and an outlet side port based on the set control signal value,
wherein the pressure of the hydraulic fluid that is supplied to the swing motor 56 is maintained not to exceed the set value during the swing of the upper swing structure, and the high-pressure hydraulic fluid that is relieved from the first and second paths to the hydraulic tank is stored in the accumulator.
